(19) United States
(12) Patent Application Publication
(10) Pub. No.: US 2013/0081007 A1
(43) Pub. Date: Mar. 28, 2013

(54) PROVIDING CONTINUOUS APPLICATION AVAILABILITY DURING APPLICATION UPDATE

(71) Applicants: GRAHAM C. CHARTERS, SOUTHAMPTON (GB); JEREMY HUGHES, WINCHESTER (GB); VALENTIN MAHRWALD, HURSLEY (GB); ALASDAIR NOTTINGHAM, SOUTHAMPTON (GB); MARK P. NUTTALL, EASTLEIGH (GB); IAN ROBINSON, SOUTHAMPTON (GB); TIMOTHY J. WARD, SOUTHAMPTON (GB)

(72) Inventors: GRAHAM C. CHARTERS, SOUTHAMPTON (GB); JEREMY HUGHES, WINCHESTER (GB); VALENTIN MAHRWALD, HURSLEY (GB); ALASDAIR NOTTINGHAM, SOUTHAMPTON (GB); MARK P. NUTTALL, EASTLEIGH (GB); IAN ROBINSON, SOUTHAMPTON (GB); TIMOTHY J. WARD, SOUTHAMPTON (GB)

(73) Assignee: INTERNATIONAL BUSINESS MACHINES CORPORATION, ARMONK, NY (US)

(21) Appl. No.: 13/246,144

(22) Filed: Sep. 27, 2011

(51) Int. Cl. G06F 9/44

(52) U.S. Cl. 717/168

(57) ABSTRACT

A first instance of the application can be executed. While the first instance of the application is executing, at least one request to access the application (first access request) can be processed by directing the first access request to the first instance of the application. Further, a request to update the application can be received. Responsive to the request to update the application, at least one new application component corresponding to the update request can be installed. A second instance of the application can be executed. The second instance can include at least one new application component.

### BACKGROUND

One or more embodiments disclosed within this specification relate to updating of an application executing on processing system.

Modern day processing systems, such as such as servers, workstations, personal computers, tablet computers, and the like, execute one or more applications. The applications sometimes are executed on an operating system, though in some cases applications are executed within an execution platform, which itself is executed on the operating system. One example of an execution platform is the Java™ Runtime Environment (JRE). The JRE consists of the Java Virtual Machine (JVM), Java platform core classes, and supporting Java platform libraries. Further expanding on Java's capabilities, the Open Services Gateway initiative provides a set of specifications that define a dynamic component system for Java™.

Oftentimes applications are updated with new releases, for example to introduce new functionality, fix bugs in the applications, etc. Generally, when an application update occurs, it is required that the application be re-started. Some applications, however, are widely used within an organization. To minimize the inconvenience of taking the applications off line when application updates are to be installed, system administrators oftentimes schedule the application updates to take place late at night or on a weekend.

### BRIEF SUMMARY

One or more embodiments disclosed within this specification relate to updating an application.

An embodiment can include, via a processor, executing a first instance of the application. While the first instance of the application is executing, at least one request to access the application (first access request) can be processed by directing the first access request to the first instance of the application. Further, a request to update the application can be received. Responsive to the request to update the application, at least one new application component corresponding to the update request can be installed. A second instance of the application can be executed while the first instance of the application continues to execute. The second instance can include at least one new application component.

Another embodiment can include a system that includes a computer-readable storage medium having computer-readable program code embodied therewith, and a processor coupled to the computer-readable storage medium. Responsive to executing the computer-readable program code, the processor can be configured to perform executable operations. Such operations can include executing a first instance of an application. The operations also can include, while the first instance of an application is executing, processing at least one request to access the application (first access request) by directing the first access request to the first instance of the application, receiving a request to update the application and, responsive to the request to update the application, installing at least one new application component corresponding to the update request. The operations further can include executing a second instance of the application inclusive of the at least one new application component while the first instance of the application continues to execute.

Another embodiment can include a computer program product. The computer program product can include a computer-readable storage medium having computer-readable program code embodied therewith, the computer-readable program code configured to perform the various steps and/or functions disclosed within this specification.

### BRIEF DESCRIPTION OF THE SEVERAL VIEWS OF THE DRAWINGS

FIG. 1 is a block diagram illustrating a system for updating an application in accordance with one embodiment of the present invention.

FIG. 2 is a flow chart illustrating a method of updating an application in accordance with another embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code embodied, e.g., stored, thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk drive (HDD), a solid state drive (SSD), a random access memory (RAM), a read-only memory (ROM), an erasable programmable read-only memory (EPROM or Flash memory), an optical fiber, a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

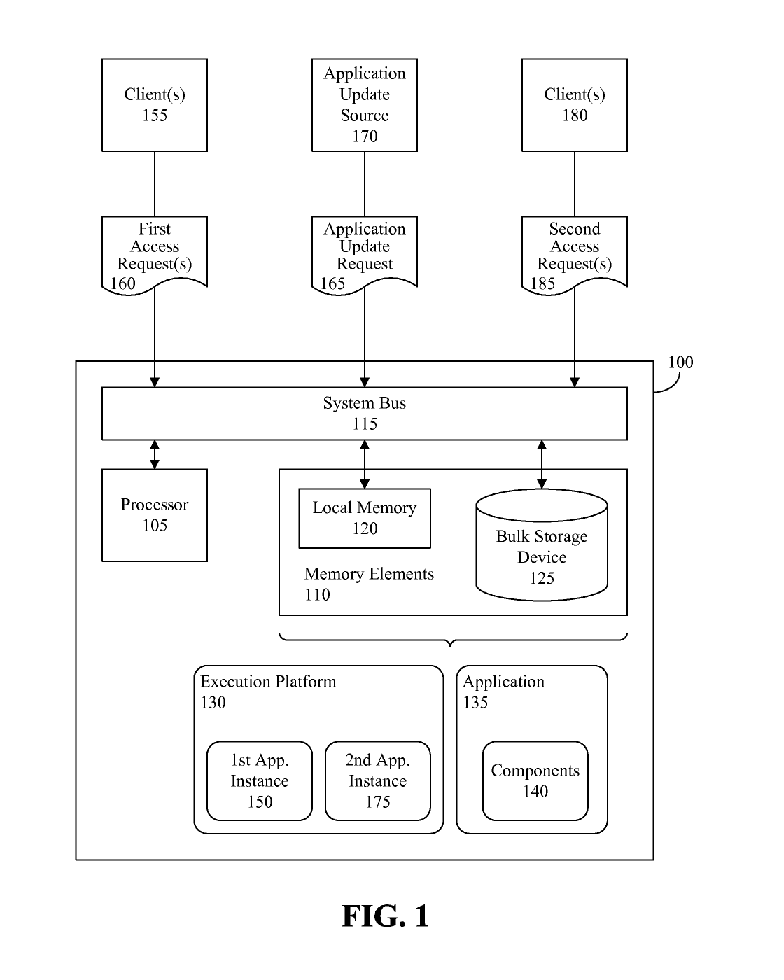

FIG. 1 is a block diagram illustrating a system 100 for updating an application in accordance with one embodiment of the present invention. In one embodiment, the system 100 can include at least one processor 105 coupled to memory elements 110 through a system bus 115. As such, the system 100 can store program code within the memory elements 110. The processor 105 can execute the program code accessed from memory elements 110 via the system bus 115. In one aspect, for example, the system 100 can be implemented as computer that is suitable for storing and/or executing program code. It should be appreciated, however, that the system 100 can be implemented in the form of any system comprising a processor and memory that is capable of performing the functions described within this specification.

The memory elements 110 can include one or more physical memory devices such as, for example, local memory 120 and one or more bulk storage devices 125. Local memory 120 refers to random access memory or other non-persistent memory device(s) generally used during actual execution of the program code. The bulk storage device(s) 125 can be implemented as a HDD, SSD, or other persistent data storage device. The system 100 also can include one or more cache memories (not shown) that provide temporary storage of at least some program code in order to reduce the number of times program code must be retrieved from bulk storage device 125 during execution.

Input/output (I/O) devices (not shown) such as a keyboard, a display, and a pointing device optionally can be coupled to the system 100. The I/O devices can be coupled to the system 100 either directly or through intervening I/O controllers. Network adapters and/or communication ports also can be coupled to the system 100 to enable the system 100 to become coupled to other systems, computer systems, remote printers, and/or remote storage devices through intervening private or public networks. Modems, cable modems, and Ethernet cards are examples of different types of network adapters that can be used with the system 100. Examples of suitable communication ports include, but are not limited to, parallel ports, serial ports, universal serial bus (USB) ports, IEEE 1394 ports, serial ATA (SATA) ports, and the like.

As pictured in FIG. 1, the memory elements 110 can store an execution platform 130, such as an OSGi® framework or another suitable framework (e.g., a “C” based framework), and at least one application 135. In one embodiment, the execution platform 130 can be implemented within the IBM® WebSphere® Application Server, though the invention is not limited in this regard. (IBM and WebSphere are trademarks of International Business Machines Corporation in the United States, other countries, or both).

In an example in which the execution platform is the OSGi® framework, the OSGi® framework can provide a standardized environment in which the application 135 executes. In this regard, the OSGI framework can be divided into a number of layers. These layers can include an execution environment, a module layer, a life cycle layer, and a service registry. The execution environment can be implemented in accordance with Java™, Foundation Profile, and/or any other suitable execution environment(s). The module layer can define class loading policies. For example, the module layer can based on Java™, and further add modularization capability to the OSGi® framework. The life cycle layer can control installation, un-installation, starting, stopping and updating of the Application 135. The service registry layer can include a service registry that provides a cooperation model for applications, such as the application 135, executing on the OSGi® Framework. The cooperation model can allow the application 135 to share objects with other applications, taking the dynamics of the execution of the applications into account.

The application 135 can include a plurality of components (or modules or classes) 140 bundled together into one or more packages for deployment. In illustration, when the execution platform 130 is an OSGI framework, the packages can be bundles as described in the OSGi® specification. As such, a bundle can comprise a Java™ Archive (JAR) file that includes a group of Java™ classes, as well as other resources which together with the JAR file provide functionality to end users. The other resources can include OSGi® metadata specified in a JAR manifest file. The metadata can specify components in the JAR file that may be exported, components that may be imported into the JAR file, as well as other information. Other documentation optionally also can be included in a bundle.

In operation, a first instance 150 of the application 135 (hereafter “first application instance”) can be executed (e.g., instantiated) on the execution platform 130, for example via the memory elements 110 and the processor 105. While the first instance 150 of the application 135 is executing, one or more clients 155 can communicate to the system 100 at least one request (hereinafter “first access request”) 160 to access the application 135. The system 100 can receive the first access request 160 via the system bus 115 and any intervening network adapters and/or communication ports. On the system 100, the execution platform 130 can direct the first access request 160 to the first application instance 150 via a first processing path. In one aspect, the first access request 160 can include a plurality of individual communication requests to the first application instance 150 during a stateful conversation, for example in an HTTP session. In this regard, each of a plurality of first access requests 160 can include a plurality of individual communication requests to the first application instance 150 during respective stateful conversations, for example in a plurality of HTTP sessions.

While the first application instance 150 continues to execute, the system 100 can receive an application update request (hereinafter “update request”) 165 from an application update source 170. In one embodiment, the application update source 170 can be another system coupled to the system 100 via the system bus 115 and any intervening network adapters and/or communication ports. In another embodiment, the application update source 170 can be a process retrieved from the memory elements 110 and executed by the processor 105. The application update source 170 can generate the update request 165 in response to a user request, in response to an automated task, or generate the update request 165 in response to any other suitable trigger.

On the system 100, the execution platform 130 can receive the update request 165. In response to the update request 165, the execution platform 130 can update at least one application component 140 corresponding to the update request 165 in order to update the application 135. The update request 165 can identify existing components 140 to be replaced or removed from the application 135 and/or add one or more new components 140 to the application 135. Such new components 140 can be provided to replace existing components 140, though this need not be the case. In one embodiment, entire bundles can be added, or identified to be replaced and/or removed. Further, during the application update one or more entries in a service registry can be updated (e.g., added, changed or removed) in accordance with the update request. In one embodiment, an original application component 140 and a new application component 140 replacing the original application component (together referred to as “shared application components”) can be in-memory representations of the respective application components 140. In illustration, the shared application components can reside in the local memory 120 or in the bulk storage device 125.

Previous versions of the components 140 and the service registry can be maintained by the execution platform 130 at least until the first application instance 150 is closed. Accordingly, the application update can be performed while the first application instance 150 continues executing, and without affecting the first application instance 150. Moreover, the first application instance 150 can continue processing the first access request(s) 160 during the application update and after the application update is complete. In this regard, the access requests 160 can be routed to the first application instance 150 even after the update request 165 is received, and the first application instance 150 may be retained as long as any conversations are still active with the first application instance 150 (or in the current parlance as long as one or more first access requests 160 are still pending).

The update request 165 can include the new application component 140, or specify where the new application component 140 is to be retrieved. For example, the update request 165 can specify a location in the memory elements 110 where the new application component 140 is stored, or specify another system communicatively linked to the system 100 from which the new application component 140 can be retrieved. In an embodiment in which the execution platform 130 is an OSGi® framework, the update request 165 also can include, or otherwise specify, one or more OSGi® resolver hooks and/or one or more OSGi® service registry hooks.

As used herein the term “resolver hook,” is an instance called by a framework during a resolve process. For example, a resolver hook may influence the outcome of a resolve process by removing entries from shrinkable collections that are passed to the hook during a resolve process. A shrinkable collection is a collection that supports all remove operations. As used herein, the term “service registry hook” is an instance called by a framework that identifies a service being requested from a service registry that relevant to a current framework.

While the first application instance 150 continues executing, a second instance 175 of the application 135 (hereinafter “second application instance”) can be executed (e.g., instantiated) on the execution platform 130, for example via the memory elements 110 and the processor 105. The first application instance 150 and the second application instance 175 can share application components 140, for example bundles, not updated (e.g., not added or identified to be replaced or removed) during the update of the application 135.

One or more clients 180 can communicate to the system 100 at least one request (hereinafter “second access request”) 185 to access the application 135. The system 100 can receive the second access request 185 via the system bus 115 and any intervening network adapters and/or communication ports. On the system 100, the execution platform 130 can direct the second access request 185 to the second application instance 175 via a second processing path, while not interfering with the first access request(s) 160 directed to the first application instance 150. In this regard, the execution platform can maintain at least two parallel processing paths, the first processing path directing to the first application instance 150 the first access request(s) 160 received prior to the application update, and the second processing path directing to the second application instance 175 the second access request(s) 185 received after the application update.

The OSGi® resolver hooks can be called when the second application instance 175 is executed to resolve the second application instance 175 against only most recent versions of the application components 140. The most recent versions can be entirely new components 140 added to the application 135 and/or components 140 added to the application 135 to replace previous versions of the components 140. Accordingly, the OSGi® resolver hooks can ensure that the second application instance 175 does not use components 140 that are replaced or removed from the application 135 during the application update. In lieu of OSGi® resolver hooks, manifest re-writing can be implemented to resolve the second application instance 175 against only most recent versions of the application components 140. The OSGi® service registry hooks also can be called when the second application instance 175 is executed to resolve the second application instance 175 against most recent versions of the application components. Together, the OSGi® resolver hooks and the OSGi® service registry hooks enable the second application instance 175 to filter resolution and service candidates to ensure that new components 140 will not resolve to, or use the services of, bundles that are about to be removed and/or replaced with updated versions of the bundles.

When the first access requests 160 are no longer pending, for instance after the first access requests 160 have been processed, the execution platform 130 can close the first application instance 150. When the first application instance 150 is closed, one or more existing components 140 replaced by new component 140, or not used in the second application instance 175, can be removed from the application 135.

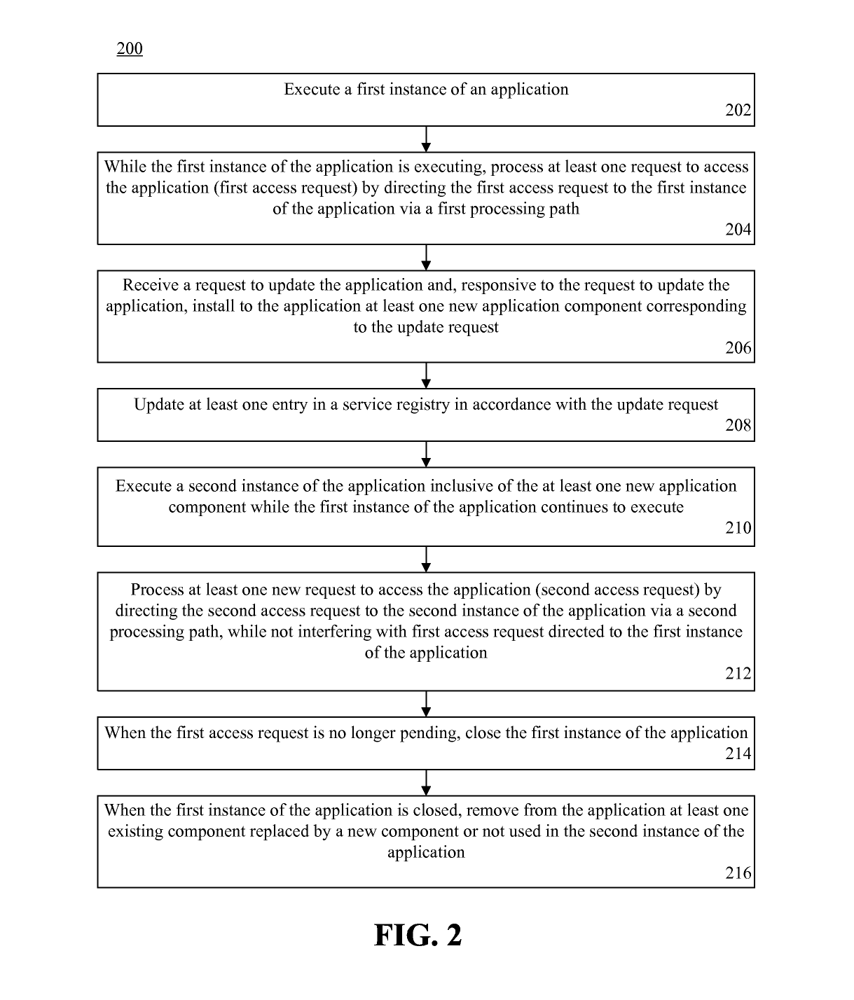

FIG. 2 is a flow chart illustrating a method 200 of updating an application in accordance with another embodiment of the present invention. At step 202, a first instance of the application can be executed, for example on the execution platform. At step 204, while the first instance of the application is executing, at least one request to access the application (first access request) can be processed by directing the first access request to the first instance of the application via a first processing path.

At step 206, a request to update the application can be received and, responsive to the request to update the application, at least one new application component corresponding to the update request can be installed to the application. For example, an existing component of the application can be updated without affecting the first instance of the application. At step 208, at least one entry in a service registry can be updated in accordance with the update request.

At step 210, a second instance of the application can be executed while the first instance of the application continues to execute, the application inclusive of the at least one new application component. The second instance of the application can be executed using OSGi® resolver hooks to resolve the second instance of the application against only most recent versions of the application components. The second instance of the application also can be executed using OSGi® service registry hooks to resolve the second instance of the application against most recent versions of the application components.

Optionally, at step 212, at least one new request to access the application (second access request) can be processed by directing the second access request to the second instance of the application via a second processing path, while not interfering with first access request directed to the first instance of the application. The first instance of the application and the second instance of the application can share application components not updated in response request to update the application.

At this point it should be noted, that steps 204-212 can be implemented while the first instance of the application is executing. In other words, after being initiated, the first instance of the application can continue executing until step 214. At step 214, when the first access request is no longer pending, the first instance of the application can be closed. At step 216, when the first instance of the application is closed, at least one existing component replaced by a new component or not used in the second instance of the application can be removed from the application.

Like numbers have been used to refer to the same items throughout this specification. The flowchart and block diagram in the Figures illustrate the architecture, functionality, and operation of possible implementations of systems, methods and computer program products according to various embodiments of the present invention. In this regard, each block in the flowchart or block diagram may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagram and/or flowchart illustration, and combinations of blocks in the block diagram and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method for updating an application, comprising:
via a processor, executing a first instance of an application; and
while the first instance of the application is executing:
processing at least one request to access the application (first access request) by directing the first access request to the first instance of the application;
receiving a request to update the application and, responsive to the request to update the application, installing to the application at least one new application component corresponding to the update request; and
executing a second instance of the application inclusive of the at least one new application component while the first instance of the application continues to execute.

2. The method of claim 1, further comprising:
processing at least one new request to access the application (second access request) by directing the second access request to the second instance of the application, while not interfering with first access request directed to the first instance of the application.

3. The method of claim 2, wherein:
the first access request is directed to the first instance of the application via a first processing path; and
the second access request is directed to the second instance of the application via a second processing path.

4. The method of claim 1, wherein the first access request comprises a plurality of individual communication requests to access the application during at least one stateful conversation.

5. The method of claim 1, further comprising:
when the first access request is no longer pending, closing the first instance of the application.

6. The method of claim 5, further comprising:
when the first instance of the application is closed, removing from the application at least one existing component replaced by a new component or not used in the second instance of the application.

7. The method of claim 1, wherein the first instance of the application and the second instance of the application share application components not updated in response request to update the application.

8. The method of claim 1, wherein the shared application components are in-memory representations of the application components.

9. The method of claim 1, wherein:
installing to the application at least one new application component comprises updating an existing component of the application without affecting the first instance of the application.

10. The method of claim 1, wherein:
executing the second instance of the application comprises configuring the second instance of the application using OSGi® resolver hooks to resolve the second instance of the application against only most recent versions of the application components.

11. The method of claim 1, further comprising:
updating at least one entry in a service registry in accordance with the update request.

12. The method of claim 11, wherein:
executing the second instance of the application comprises configuring the second instance of the application using OSGi® service registry hooks to resolve the second instance of the application against only most recent versions of the application components.

13. A system comprising:
a computer-readable storage medium having computer-readable program code embodied therewith;
a processor coupled to the computer-readable storage medium, wherein responsive to executing the computer-readable program code, the processor is configured to perform executable operations comprising:
executing a first instance of an application; and
while the first instance of the application is executing:
processing at least one request to access the application (first access request) by directing the first access request to the first instance of the application;
receiving a request to update the application and, responsive to the request to update the application, installing at least one new application component corresponding to the update request; and
executing a second instance of the application inclusive of the at least one new application component while the first instance of the application continues to execute.

14. The system of claim 13, said executable operations further comprising:
processing at least one new request to access the application (second access request) by directing the second access request to the second instance of the application, while not interfering with first access request directed to the first instance of the application.

15. The system of claim 13, said executable operations further comprising:
when the first access request is no longer pending, closing the first instance of the application.

16. A computer program product, the computer program product comprising:
a computer-readable storage medium having computer-readable program code embodied therewith, the computer-readable program code comprising:
computer-readable program code configured to execute a first instance of an application; and
computer-readable program code configured to, while the first instance of the application is executing:
process at least one request to access the application (first access request) by directing the first access request to the first instance of the application;
receive a request to update the application and, responsive to the request to update the application, installing at least one new application component corresponding to the update request; and
execute a second instance of the application inclusive of the at least one new application component while the first instance of the application continues to execute.

17. The computer program product of claim 16, the computer-readable program code further comprising:
computer-readable program code configured to process at least one new request to access the application (second access request) by directing the second access request to the second instance of the application, while not interfering with first access request directed to the first instance of the application.

18. The computer program product of claim 17, wherein:
the first access request is directed to the first instance of the application via a first processing path; and
the second access request is directed to the second instance of the application via a second processing path.

19. The computer program product of claim 16, the computer-readable program code further comprising:
computer-readable program code configured to, when the first access request is no longer pending, close the first instance of the application.

20. The computer program product of claim 19, the computer-readable program code further comprising:
computer-readable program code configured to, when the first instance of the application is closed, remove at least one existing component replaced by a new component or not used in the second instance of the application.
